(19) United States
(12) Patent Application Publication
(10) Pub. No.: US 2012/0162700 A1
(43) Pub. Date: Jun. 28, 2012

(54) IMAGE FORMING SYSTEM, IMAGE FORMATION DESIGNATING APPARATUS AND COMPUTER READABLE MEDIUM

(75) Inventor: Mariko MIYAZAKI, Kanagawa (JP)

(73) Assignee: FUJI XEROX CO., LTD., Minato-ku (JP)

(21) Appl. No.: 13/174,011

(22) Filed: Jun. 30, 2011

(30) Foreign Application Priority Data
Dec. 24, 2010 (JP) 2010-288651

(51) Int. Cl. G06K 15/00

(52) U.S. Cl. 358/1.15

(57) ABSTRACT

An image forming system includes an image formation designating apparatus and a given image forming apparatus. The image formation designating apparatus includes a common function setting information acquisition unit, an acquisition unit, an integrated function setting information generating unit, a presentation unit, a receiving unit, an image formation designating information generating unit, and a transmitting unit. The given image forming apparatus includes a holding unit, a unit, a receiving unit, and an image forming unit.

### CROSS-REFERENCE TO RELATED APPLICATIONS

This application is based upon and claims priority under 35 USC 119 from Japanese Patent Application No. 2010-288651, filed Dec. 24, 2010.

### BACKGROUND

### Technical Field

The present invention relates to an image forming system, an image formation designating apparatus and a computer readable medium.

### SUMMARY OF THE INVENTION

According to an aspect of the invention, an image forming system includes an image formation designating apparatus and a given image forming apparatus. The image formation designating apparatus includes a common function setting information acquisition unit, an acquisition unit, an integrated function setting information generating unit, a presentation unit, a receiving unit, an image formation designating information generating unit, and a transmitting unit. The given image forming apparatus includes a holding unit, a unit, a receiving unit, and an image forming unit. A common function setting information acquisition unit acquires common function setting information for setting a function common to a plurality of image forming apparatuses including the given image forming apparatus. The acquisition unit acquires function setting information of the given image forming apparatus which is a destination of transmission of image formation designation from the given image forming apparatus, the function setting information including setting screen layout information for defining contents of a setting screen and setting item display information for defining a setting value corresponding to a function of the given image forming apparatus. The integrated function setting information generating unit integrates the common function setting information acquired by the common function setting information acquisition unit with the function setting information acquired by the acquisition unit and generates integrated function setting information based on the setting screen layout information and the setting item display information. The presentation unit presents a setting screen based on the integrated function setting information generated by the integrated function setting information generating unit. The receiving unit receives designation concerned with a setting of the function. The image formation designating information generating unit generates image formation designating information based on the designation received by the receiving unit and image information which is a target of image formation by the given image forming apparatus. The transmitting unit transmits the image formation designating information generated by the image formation designating information generating unit to the given image forming apparatus. The holding unit holds function setting information concerned with functions and settings which is usable by the image forming apparatus. The unit receives a request to acquire the function setting information held by the holding unit from the image formation designating apparatus and transmits the function setting information to the image formation designating apparatus. The receiving unit receives the image formation designating information from the image formation designating apparatus. The image forming unit forms an image based on the received image formation designating information.

### BRIEF DESCRIPTION OF THE DRAWINGS

Exemplary embodiments of the invention will be described in detail based on the following figures, wherein:

FIG. 1 is a block diagram of configuration of an image forming system according to an exemplary embodiment of the invention;

FIG. 2 is an explanatory view showing an example of contents of common function setting information acquired by an image formation designating apparatus according to the exemplary embodiment of the invention;

FIG. 3 is an explanatory view showing an example of a setting screen presented by the image formation designating apparatus according to the exemplary embodiment of the invention;

FIG. 4 is an explanatory view showing an example of contents of function setting information acquired by the image formation designating apparatus according to the exemplary embodiment of the invention;

FIG. 5 is an explanatory view showing an example of contents of restriction information acquired by the image formation designating apparatus according to the exemplary embodiment of the invention;

FIG. 6 is a functional block diagram showing an example of the image formation designating apparatus according to the exemplary embodiment of the invention;

FIG. 7 is an explanatory view showing an example of a setting screen generated based on common function setting information acquired by the image formation designating apparatus according to the exemplary embodiment of the invention;

FIG. 8 is a flow chart showing an example of operation of the image formation designating system according to the exemplary embodiment of the invention;

FIG. 9 is an explanatory view showing an example of a setting screen containing setting items generated by the image formation designating apparatus according to the exemplary embodiment of the invention; and

FIG. 10 is an explanatory view showing an example of a setting screen containing setting items after integration, presented by the image formation designating apparatus according to the exemplary embodiment of the invention.

### DETAILED DESCRIPTION

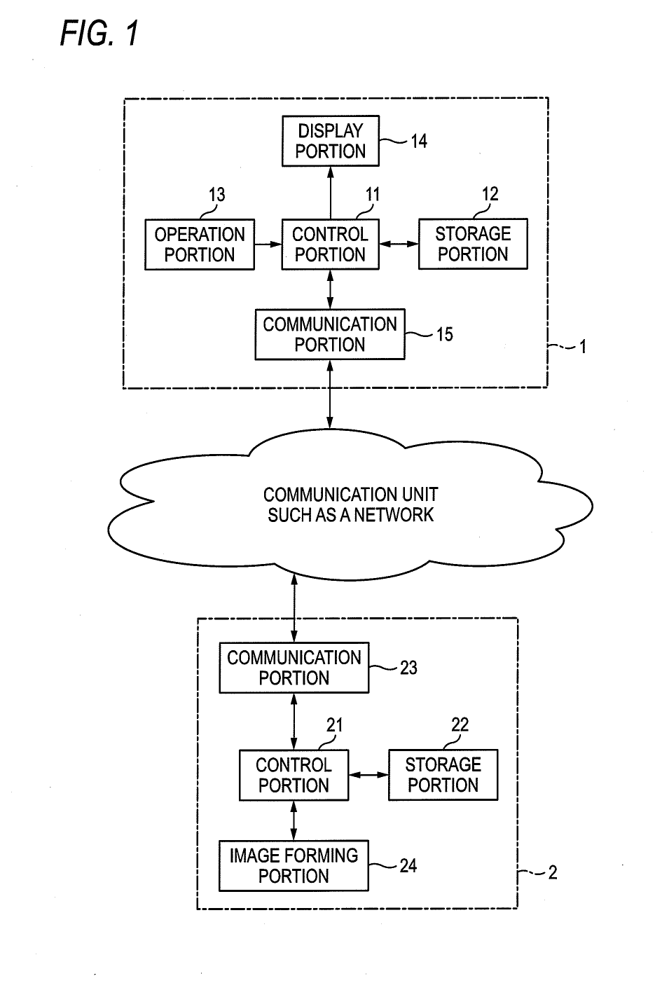

An exemplary embodiment of the invention will be described below with reference to the drawings. As shown in FIG. 1, an image forming system according to the exemplary embodiment of the invention includes an image formation designating apparatus 1 and an image forming apparatus 2 connected to each other through a communication unit such as a network.

The image formation designating apparatus 1 according to the exemplary embodiment of the invention includes a control portion 11, a storage portion 12, an operation portion 13, a display portion 14, and a communication portion 15. The control portion 11 is a program control device such as a CPU (Central Processing Unit) which performs processing in accordance with a program stored in the storage portion 12. In this exemplary embodiment, the control portion 11 acquires function setting information containing setting screen layout information and function restriction information held by the image forming apparatus 2 from the image forming apparatus 2 which is a destination of transmission of image formation designation. The control portion 11 integrates the function setting information acquired previously with common function setting information stored in the storage portion 12 in advance to thereby generate integrated function setting information containing setting screen information generated based on the setting screen layout information and the function restriction information. The control portion 11 generates setting screen display information based on the setting screen information contained in the thus generated integrated function setting information to make the display portion 14 display the setting screen display information, receives an input of designation concerned with function setting inputted by a user through the operation portion 13, and generates image formation designation based on the received designation and image information as a target of formation. Then, the control portion 11 transmits the image formation designation to the image forming apparatus which is a destination of transmission of image formation designation. These contents of processing performed by the control portion 11 will be described later in detail.

The storage portion 12 may include a memory device, a disk device, etc. The storage portion 12 holds a program to be executed by the control portion 11. In this exemplary embodiment, this program may be provided in a state that the program stored in a computer-readable recording medium such as a DVD-ROM (Digital Versatile Disc Read Only Memory) so that the program will be stored in the storage portion 12. Image forming apparatuses of different types or with different additional functions are assumed so that each function common to these image forming apparatuses is extracted and common function setting information which is setting information concerned with the extracted function is stored in the storage portion 12. Specific contents of the common function setting information will be described later. The storage portion 12 operates also as a work area for the control portion 11.

The operation portion 13 is an input device such as a mouse, a keyboard, etc. The operation portion 13 receives a user's operation and outputs contents of the operation to the control portion 11. The display portion 14 is a display device such as a display, etc. The display portion 14 displays a setting screen concerned with an operation based on display information generated by the control portion 11. The communication portion 15 exchanges information with an external apparatus (e.g. the image forming apparatus 2) through a communication unit such as a network interface, a modem, etc.

As shown in FIG. 1, the image forming apparatus 2 includes a control portion 21, a storage portion 22, a communication portion 23, and an image forming portion 24. The control portion 21 is a program control device such as a CPU, etc. which operates in accordance with a program stored in the storage portion 22. The control portion 21 performs a process of receiving a request to acquire function setting information stored in the storage portion 22 from the image formation designating apparatus 1 and transmitting the function setting information to the image formation designating apparatus 1 as a requester and a process of receiving image formation designation from the image formation designating apparatus 1 and controlling the image forming portion 24 to form an image based on the received image formation designation.

The storage portion 22 holds a program to be executed by the control portion 21. This program may be provided in a state where the program is stored in a computer-readable recording medium such as a DVD-ROM, etc. so that the program will be stored in the storage portion 22. The storage portion 22 further holds function setting information concerned with functions and settings which may be used in the image forming apparatus 2. The function setting information will be described later. The communication portion 23 receives/transmits information through the communication unit such as a network interface card, a modem, etc.

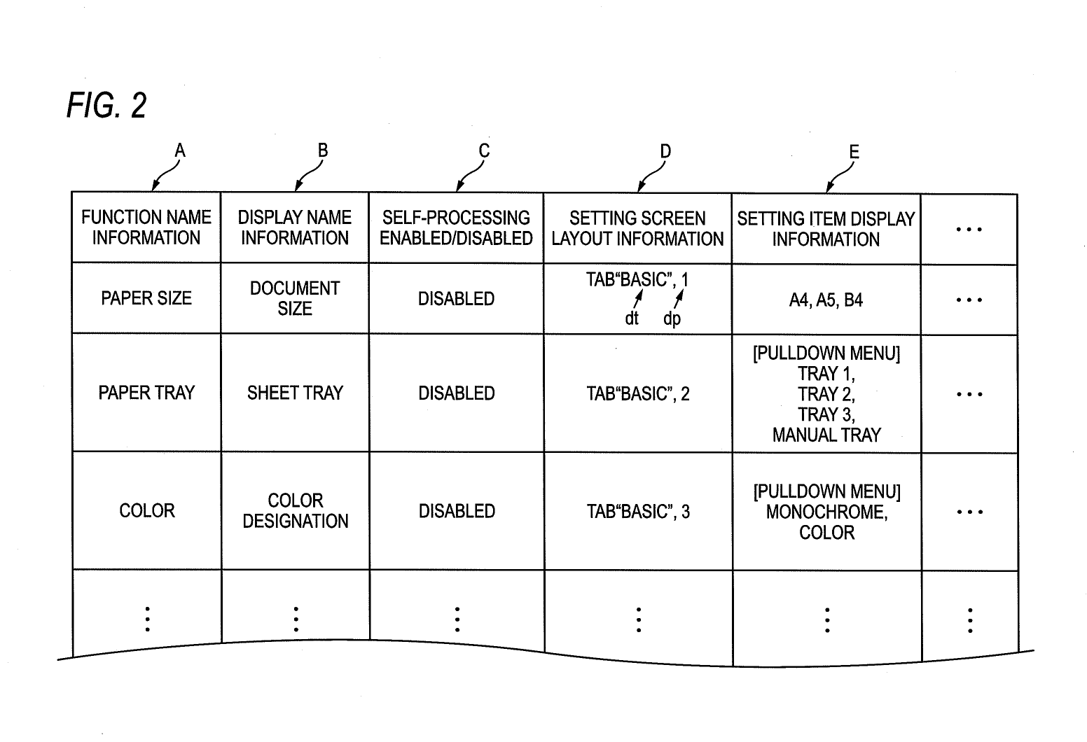

An example of common function setting information held in the storage portion 12 of the image formation designating apparatus 1 will be described here. For example, as shown in FIG. 2, the common function setting information contains at least one function setting information item in which function name information (A), display name information (B), self-processing enabled/disabled information (C) indicating whether processing on the image formation designating apparatus 1 side is enabled or not, setting screen layout information (D) and setting item display information (E) are associated with one another.

The function name information (A) is function identifying information determined in accordance with each function in advance. Specifically, the function name information (A) is expressed in a character string “PaperSize” or the like or identification information in sheet size setting. The display name information (B) is the name of the function expressed in the setting screen. The display name information (B) is expressed in a character string “document size” or the like. The self-processing enabled/disabled information (C) indicates whether processing on the image formation designating apparatus 1 side is enabled or not. For example, as for processing enabled on the image formation designating apparatus 1 side, such as image processing performed by a software program, the self-processing enabled/disabled information (C) is set as “enabled”. As for processing enabled only on the image forming apparatus 2 side, such as sheet size setting, presence/absence of stapler, etc., the self-processing enabled/disabled information (C) is set as “disabled”.

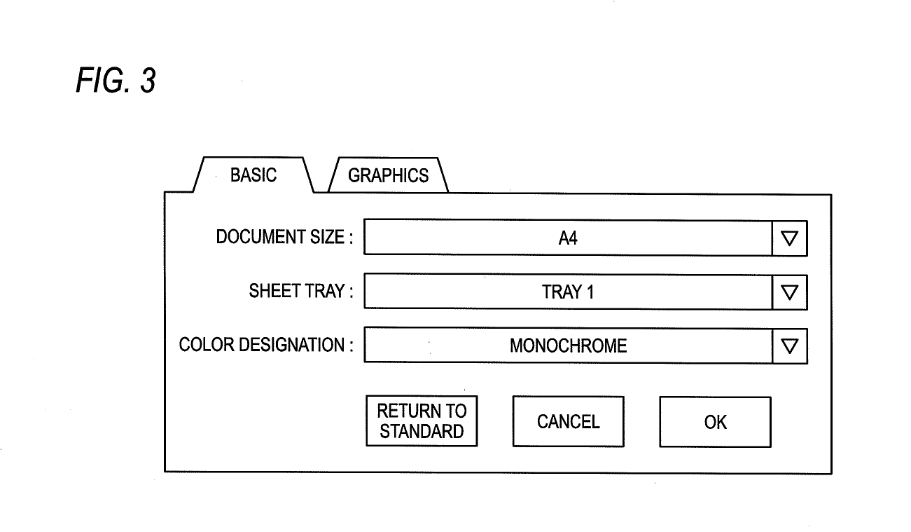

The setting screen layout information (D) is information indicating layout of areas in the setting screen. In an example in this exemplary embodiment, as shown in FIG. 3, the setting screen contains pages each of which can be changed when a corresponding caption portion called “tab” is selected and designated. Each page contains at least one setting item group.

When such a setting screen is displayed, the setting screen layout information (D) at least contains information (dt) indicating a page corresponding to the tab, and information (dp) indicating display order in the page.

The setting item display information (E) contains information for specifying the type of a component displayed for operation or setting, and relevant setting values (such as a list of options). The setting item display information (E) may further contain information indicating an initial value. The type of each user interface component used for screen display or setting input for setting various setting items contains a check box, a radio button, a pull-down menu, etc. Detailed description of the component type will be omitted because the component type is known well as a constituent element of general graphical user interface technology.

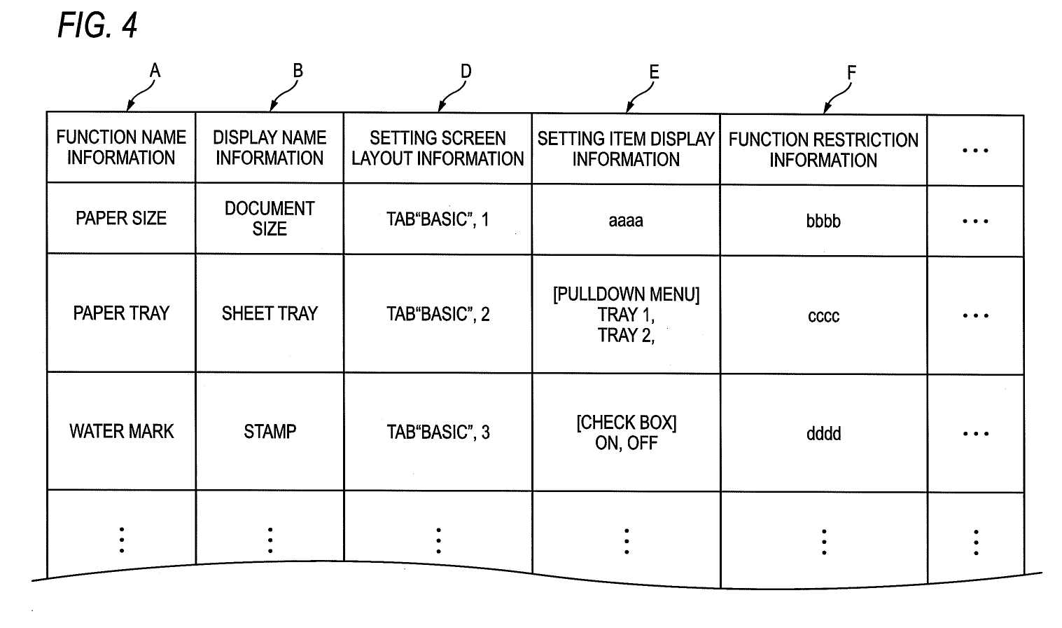

Further, an example of the function setting information stored in the storage portion 22 of the image forming apparatus 2 in this exemplary embodiment will be described. In an example in this exemplary embodiment, as shown in FIG. 4, the function setting information contains at least one function setting item in which function name information (A), display name information (B), setting screen layout information (D), setting item display information (E) and function restriction information (F) are associated with one another.

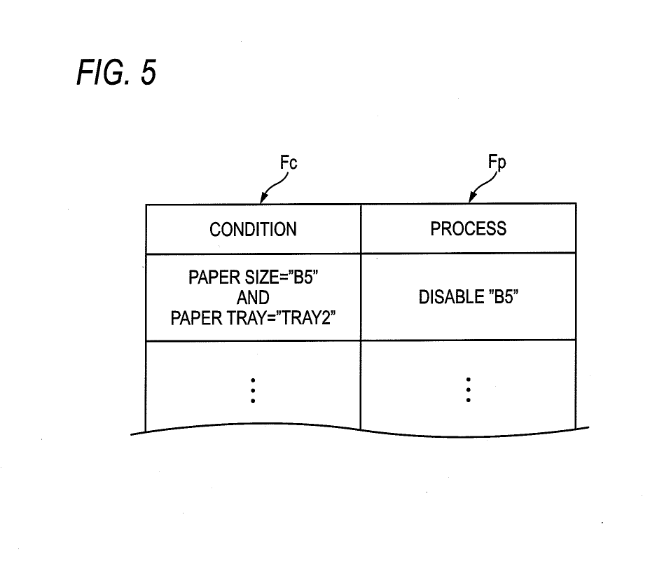

Although the function name information (A), the display name information (B), the setting screen layout information (D) and the setting item display information (E) are the same as those in the common function setting information which has been already described, the function setting information is different from the common function setting information in that the function setting information contains the function restriction information (F). The function restriction information (F) is information indicating a list of contradictory cases to prevent contradiction to a function or setting contained in the common function setting information. Specifically, as shown in FIG. 5, a condition (Fc) is associated with a process (Fp) to be performed when the condition is satisfied. In the example shown in FIG. 5, there is description that the setting screen is controlled to disable “B5” when an inputted condition (PaperSize=“B5” and PaperTray=“Tray2”) is satisfied. That is, FIG. 5 shows the case where “B5” size paper cannot be disposed in the sheet tray “Tray2” of the image forming apparatus 2.

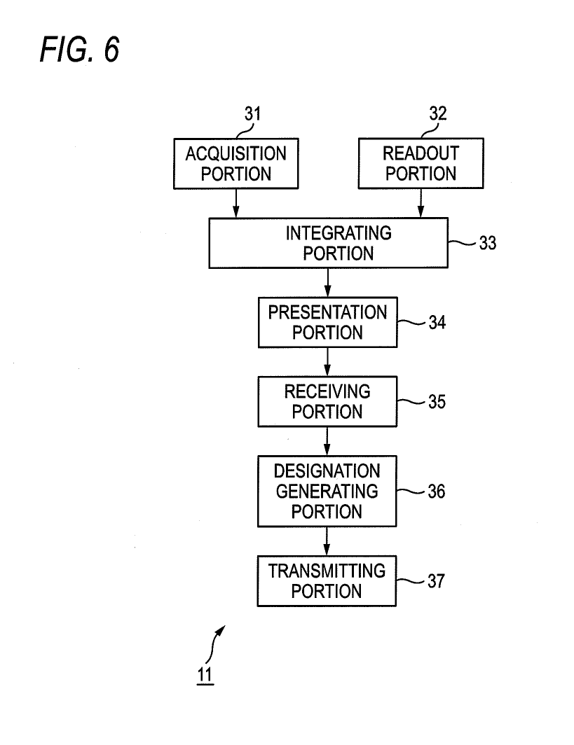

Operation of the control portion 11 in this exemplary embodiment will be described next. As shown in FIG. 6, the control portion 11 functionally includes an acquisition portion 31, a readout portion 32, an integrating portion 33, a presentation portion 34, a receiving portion 35, a designation generating portion 36, and a transmitting portion 37.

The acquisition portion 31 requests the image forming apparatus 2 (designated as a destination of transmission of image formation designation by the user) to acquire function setting information containing setting screen layout information and function restriction information held by the image forming apparatus 2. The acquisition portion 31 receives and acquires the function setting information transmitted by the image forming apparatus 2 in response to this request and stores the function setting information in the storage portion 12. The readout portion 32 reads out the common function setting information stored in the storage portion 12 in advance and the function setting information stored in the storage portion 12 by the acquisition portion 31. Although this exemplary embodiment shows the case where the common function setting information is stored in the storage portion 12 in advance, the common function setting information may be acquired from an external server or disk device. In this case, the readout portion 32 acquires the common function setting information from a device which holds the common function setting information.

The integrating portion 33 integrates the read common function setting information and the read function setting information (hereinafter referred to as function setting information simply) with each other and generates setting screen information for displaying a setting screen for receiving setting of a function setting item contained in at least one of the common function setting information and the function setting information. Specifically, this integrating process includes a process of generating setting screen information by using setting screen layout information and setting item display information contained in each of the common function setting information and the function setting information.

The setting screen information is information which defines the configuration of the setting screen and which contains information such as names of tabs to be displayed, the number of the tabs, sizes of the tabs, character strings to be displayed in the tabs respectively, layout positions of the tabs, sizes and layout positions of input columns, character strings contained in buttons, pull-down menus, etc., sizes and layout positions of the character strings, etc.

The integrating portion 33 sets the common function setting information per se as temporary integrated function setting information in the integrating process. The integrating portion 33 one-by-one reads out function setting items corresponding to respective pieces of function name information contained in the function setting information stored in the storage portion 12. Then, the integrating portion 33 checks whether the function name information of each read function setting item is contained in the temporary integrated function setting information or not.

When the function name information of the read function setting item is not contained in the temporary integrated function setting information, the integrating portion 33 adds the read function setting item to the temporary integrated function setting information directly.

On the other hand, when the function name information of the read function setting item is contained in the temporary integrated function setting information, the integrating portion 33 adds the read function setting item to the temporary integrated function setting information and performs integration so that the setting screen information of the temporary integrated function setting information contains setting items such as a corresponding function setting item of the common function setting information and a read function setting item, and information indicating which setting value is selected. The integrating portion 33 performs the aforementioned process for each read function setting item. When the integrating process is completed for all function setting items, the integrating portion 33 outputs the temporary integrated function setting information as integrated function setting information containing setting screen information.

The presentation portion 34 generates and presents a setting screen based on the setting screen information contained in the integrated function setting information. The receiving portion 35 receives a user's operation on the presented setting screen. The receiving portion 35 receives a designation input concerned with function setting in accordance with the user's operation.

The designation generating portion 36 generates image formation designating information based on designation (setting information concerned with image formation) received from the user by the receiving portion 35 and information (e.g. drawing information written in a page descriptive language) for drawing an image to be formed. Because the operation of the designation generating portion 36 is a process of generating image formation designating information to be outputted to the image forming apparatus 2, based on setting information concerned with image formation and information for drawing an image as a target of image formation and the same process as a broadly known process can be used, detailed description of the operation will be omitted here. The transmitting portion 37 transmits the image formation designating information generated by the designation generating portion 36 to the image forming apparatus 2 as a destination of transmission of the image formation designating information.

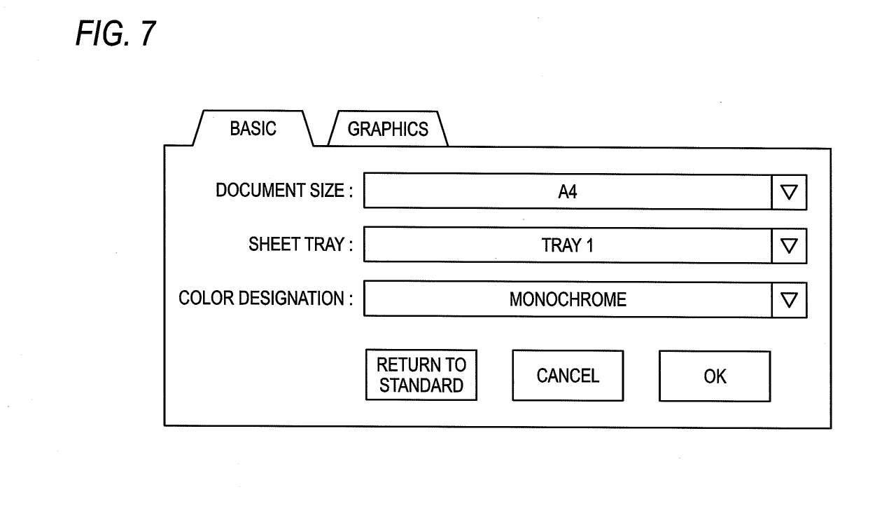

The image forming system according to this exemplary embodiment is configured as described above and operates as follows. In the following description, an example of the setting screen generated based on display name information (B), setting screen layout information (D) and setting item display information (E) contained in the common function setting information has two tabs “basic” and “graphics” as shown in FIG. 7. Pull-down menus for selecting function setting values corresponding to functions “document size” (corresponding function name information: PaperSize), “sheet tray” (corresponding function name information: PaperTray) and “color designation” (corresponding function name information: Color), an OK button, a cancel button and a “return to standard” button are arranged in the “basic” tab. Assume that the document size is “A4”, the sheet tray is “Tray1” and the color designation is “monochrome” as initial setting when the setting screen is opened. Incidentally, when the “return to standard” button is clicked, the control portion 11 sets options to be default values respectively.

In the following description, setting screen layout information (D) and setting item display information (E) contained in the function setting information acquired from the image forming apparatus 2 contain a pull-down menu for selecting “sheet size” (corresponding function name information: PaperSize) and a check box for setting “stamp” (function name information: WaterMark).

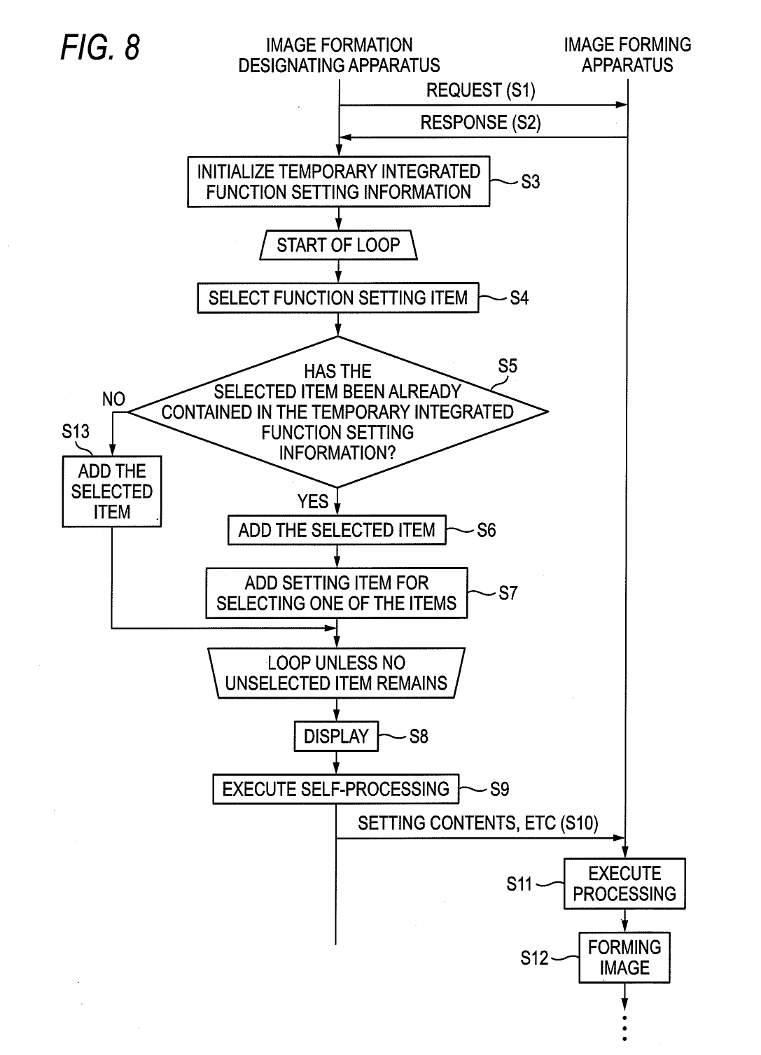

As shown in FIG. 8, when the user selects the image forming apparatus 2 as a destination of transmission of image formation designation, the image formation designating apparatus 1 requests the selected image forming apparatus 2 to transmit function setting information containing setting screen layout information and function restriction information held by the image forming apparatus 2 (S1). Upon reception of the request, the image forming apparatus 2 transmits function setting information held in advance (S2).

The image formation designating apparatus 1 reads out common function setting information stored in advance and starts an integrating process. In the integrating process, the common function setting information is first set as temporary integrated function setting information (S3). Assuming now that setting screen information in this exemplary embodiment is written, for example, in HTML (Hyper Text Markup Language), then setting screen information contained in temporary integrated function setting information here is generated as follows, for example, with respect to the “basic” tab.

...
<form name=”basic” action=”xxxxx” enctype=”text/plain”>
<p><label>document size:<select name=”PaperSize”
property=”PrinterOnly”>
<option value=”A4” selected>A4</option>
<option value=”A5”>A5</option>
<option value=”B4”>B4</option>
<option value=”B5”>B5</option>
</select>
</label></p>
<p><label>sheet tray:<select name=”PaperTray” property=”PrinterOnly”>
<option value=”tray1” selected>tray 1</option>
<option value=”tray2”>tray 2</option>
<option value=”manual feed”>manual feed</option>
</select>
</label></p>
<p><label>color designation:<select name=”Color”
property=”Processable”>
...
<p>
<input type=”submit” value=”OK”>
...
</p>
</form>
...

Incidentally, information indicating the display size of each selection item is not shown here.

In a user interface component corresponding to each function setting item, there is contained information (property information) which is set to be “Processable” when the image formation designating apparatus 1 can perform self-processing, but is set to be “PrinterOnly” when the image formation designating apparatus 1 cannot perform self-processing based on self-processing enabled/disabled information. Further, definition is made so that “selected” is contained as a default option. In this example, HTML data is prepared in accordance with each tab so that the setting screen information written in HTML is displayed in the tab portion.

Then, the following process is repeated in accordance with each function setting item contained in the function setting information transmitted in the step S2.

The image formation designating apparatus 1 selects one of unselected function setting items contained in the function setting information (S4). Then, the image formation designating apparatus 1 refers to function name information of the selected function setting item to check whether the function name information has been already contained in the temporary integrated function setting information or not (S5). That is, this process is a process for checking whether there is any function setting item concerned with function name information common to both common function setting information and function setting information or not.

When determination in the step S5 results in that the function name information used for reference has been already contained in the temporary integrated function setting information (S5: Yes), the image formation designating apparatus 1 adds the read function setting item to the temporary integrated function setting information (S6) and adds a setting item for selecting either of a corresponding function setting item in the common function setting information and the read function setting item to the setting screen information of the temporary integrated function setting information (S7).

As an example here, there is a function setting item “PaperSize” common to both the common function setting information and the function setting information. Therefore, for example, the image formation designating apparatus 1 adds a pull-down menu (as a user interface component for selecting a setting value of either function setting written in the common function setting information on the image formation designating apparatus 1 side or function setting written in the function setting information on the image forming apparatus 2 side) to the “PaperSize” item. Specifically, when a pull-down menu is to be added to HTML data described above, options set in the common function setting information and the function setting information respectively may be switched by use of a script language such as javascript.

<script type=”text/javascript”>
<!--
function PaperSizeOptionsChange( )
{

if(document.forms.basic.PaperSizeOptions.selectedIndex==”Common”){

PaperSize.options[0]=newOption(“A4”);

...

}

if(document.forms.basic.PaperSizeOptions.selectedIndex=”Printer”){

PaperSize.options[0]=new Option (“A4”);

...

}

//-->
</script>
...

<p><label>document size:<select name=”PaperSizeOptions”
onChange=”PaperSizeOptionsChange”property=”PrinterOnly”>
<option value=”Common” selected>use common function setting information</option>
<option value=”Printer”>use function setting information on image forming apparatus
side</option>
</select>:
<select name:”PaperSize”>
</select>
</label></p>
...

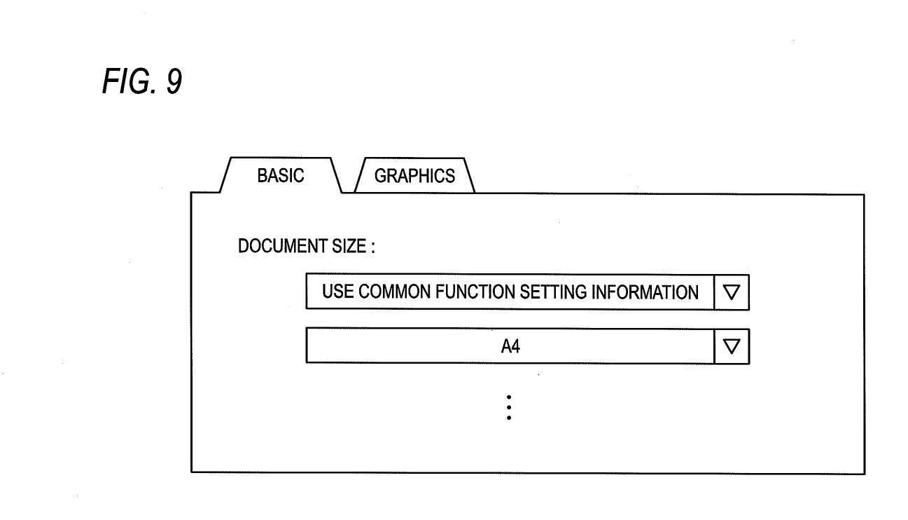

Incidentally, an example of the setting screen after the addition is as shown in FIG. 9.

In FIG. 9, the function name information is the same as “PaperSize” but the display name information defined in the common function setting information is “document size” different from “sheet size” defined in the function setting information. In this case, the image formation designating apparatus 1 may use any display name information so that the display name information is displayed together with a corresponding user interface component (in this case, a pull-down menu of function name information “PaperSize”). The image formation designating apparatus 1 may use any display name information in accordance with which of the common function setting information stored in the image formation designating apparatus 1 side in advance and the function setting information acquired from the image forming apparatus 2 side is selected, so that the display name information is displayed together with a corresponding user interface component. For example, the image formation designating apparatus 1 may generate setting screen information so that display name information contained in a function setting item selected in accordance with setting item selection for selecting either of function setting items of the common function setting information and the function setting information is used and displayed together with a corresponding user interface component.

The image formation designating apparatus 1 repeats processing of the step S4 and steps after the step S4 unless no unselected function setting item remains in the function setting items defined in the function setting information. When there is no unselected function setting item, the image formation designating apparatus 1 uses the generated temporary integrated function setting information as integrated function setting information containing setting screen information so that the image formation designating apparatus 1 may receive setting from the user while displaying a setting screen generated based on the integrated function setting information (S8).

When the user designates execution of a printing process after the image formation designating apparatus 1 receives a user's setting on the setting screen, the image formation designating apparatus 1 performs self-processing such as image processing on image forming information as a target of formation in accordance with the setting and generates drawing information written in a page descriptive language from the image forming information (S9). The image formation designating apparatus 1 generates image formation designating information based on the generated drawing information and the setting value of the setting information set by the user and transmits the image formation designating information to the image forming apparatus 2 (S10). When there is a process to be performed by the image forming apparatus 2, the image forming apparatus 2 performs the process in accordance with setting contents of the setting information contained in the transmitted image formation designating information and drawing information (S11), and forms an image (S12).

On the other hand, when determination in the step S5 results in that the function name information used for reference is not contained in temporary integrated function setting information (S5: No), the image formation designating apparatus 1 adds the read function setting item to the temporary integrated function setting information (S13). For example, in this example here, a check box for setting “stamp” (function name information: WaterMark) is contained in the function setting information but this information is not contained in the temporary integrated function setting information. Therefore, the image formation designating apparatus 1 adds the check box for setting “stamp” to the temporary integrated function setting information directly. On this occasion, the image formation designating apparatus 1 refers to information (dt) and information (dp) contained in a function setting item with respect to “stamp”. The information (dt) indicates a tab's page. The information (dp) indicates display order in this page. Assume now that “basic” is set as the information indicating a tab's page to which “stamp” is assigned, and that “4” is set as display order. Assume further that, in the common function setting information etc., function name information “PaperSize” has the display order of “1”, “PaperTray” has the display order of “2”, “Color” has the display order of “10”, and buttons such as “OK” have the display order of “99”. In this case, an HTML statement to display the check box of “stamp” having the display order of “4” is provided between “PaperTray” having the display order of “2” and “Color” having the display order of “10”.

Further, the image formation designating apparatus 1 repeats processing of the step S4 and steps after the step S4 unless no unselected function setting item remains in the function setting information. The image formation designating apparatus 1 goes to the step S8 when there is no unselected function setting item.

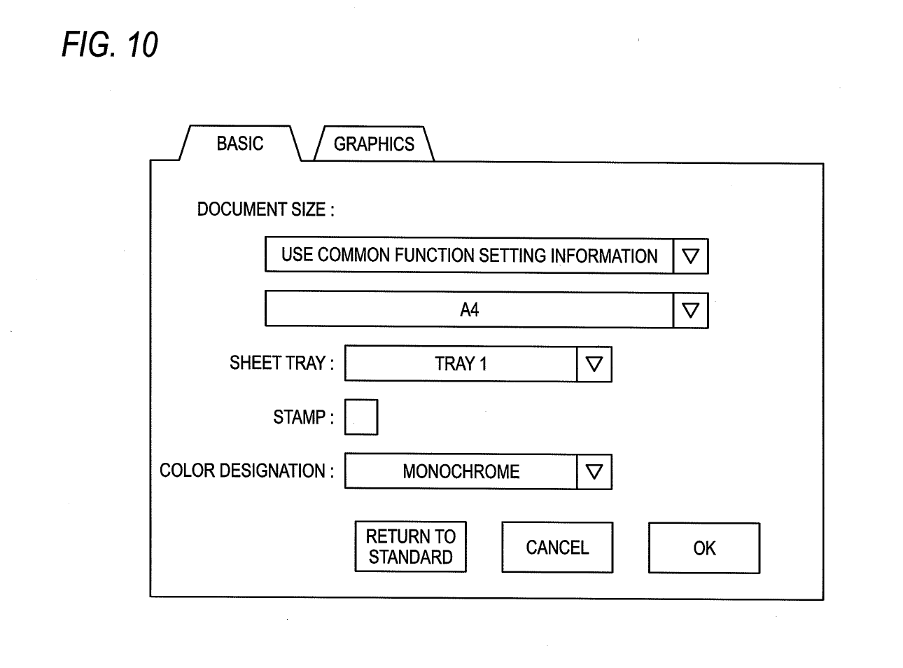

In the aforementioned example, the setting screen displayed in the step S8 of the image formation designating apparatus 1 is as shown in FIG. 10. As shown in this example, in this exemplary embodiment, function setting prepared in advance as the common function setting information and corresponding function setting of the image forming apparatus 2 contained in the function setting information are integrated without any overlap so as to be used for user's setting work.

In addition, the image formation designating apparatus 1 selects a process concerned with setting containing enabled self-processing (property is “Processable” in the aforementioned example of HTML) as a process to be performed by the image formation designating apparatus 1 in step S9. In the aforementioned example of HTML, setting of function name information “Color” contains enabled self-processing, so that a process (concerned with color adjustment) according to this function setting item is performed on the image formation designating apparatus 1 side.

A process concerned with setting containing disabled self-processing (property is “PrinterOnly” in the aforementioned example of HTML) is not performed.

In step S11 on the image forming apparatus 2 side, a process concerned with setting containing disabled self-processing (property is “PrinterOnly” in the aforementioned example of HTML) on the image formation designating apparatus 1 side is executed selectively. In the aforementioned example of HTML, setting etc. of function name information “PaperSize” contains disabled self-processing, so that a process (sheet size selecting process) according to this function setting item is performed on the image forming apparatus 2 side.

Further, the image formation designating apparatus 1 refers to function restriction information (F) contained in a function setting item corresponding to the function subjected to function setting during the user's function setting process in the step S8 to thereby determine whether the condition (Fc) defined in the function restriction information is satisfied or not. When the determination results in that the condition is satisfied, a process associated with the condition is executed as a process (Fp) to be performed. For example, when the user selects a sheet tray “Tray2” while the user selects a sheet size “B5”, the image formation designating apparatus 1 refers to function restriction information shown in FIG. 5 to thereby determine that the selected combination of the sheet size and the sheet tray is disabled. As a display format, ““B5 sheet size” and “sheet tray 2” cannot be selected simultaneously” may be displayed to prompt the user to perform another setting.

### Process Using Processing Load

Further, the image formation designating apparatus 1 according to this exemplary embodiment may perform the following process. That is, the image formation designating apparatus 1 acquires resource information concerned with processing resources of the image forming apparatus 2 as a destination of transmission of image formation designation. Then, the image formation designating apparatus 1 compares the acquired resource information of the image forming apparatus 2 with resource information concerned with processing resources of the image formation designating apparatus 1 per se. Then, the image formation designating apparatus 1 generates information indicating processing loads with respect to processing of overlapping function setting items when the processing is performed on the function setting items in the image forming apparatus 2 and the image formation designating apparatus 1 respectively. Then, the image formation designating apparatus 1 generates setting screen information indicating setting screens for displaying the overlapping function setting items respectively by using the processing load information. Specifically, when a setting item for selecting either of a function setting item corresponding to the common function setting information and a read function setting item is added to setting screen information of temporary integrated function setting information in the step S7, the image formation designating apparatus 1 displays processing load at the time of selection of the common function setting information (processing load at the time of processing on the image formation designating apparatus 1 side) and processing load at the time of selection of the function setting information (processing load at the time of processing on the image forming apparatus 2 side) on setting screens.

Specifically, the resource information mentioned herein is information obtained by numerically measuring information such as the program processing speed (operating frequency, a benchmark test result, etc.) of a program control device such as the control portion 11, the control portion 21, etc., the capacity of a work area in the storage portion 12 or the like, the reading/writing speed thereof, the bus transfer rate, etc. As an example, the resource information may be provided as vector information (clk, ispecfp, mem, rw) in which respective values of the operating frequency clk, the reciprocal ispecfp of a floating-point operation benchmark test result, the work area capacity mem and the reading/writing speed rw are arranged so that throughput capacity becomes high as each value becomes as high as possible (or throughput capacity becomes high as each value becomes as low as possible.

In this exemplary embodiment, for example, weights of the respective values in the resource information are associated as vector information with the function setting items contained in the common function setting information and the function setting information, respectively, in consideration of the loads at the time of processing corresponding to the respective function setting items so that the vector information is added to the common function setting information and the function setting information. As an example, when floating-point operation and memory capacity are important for performing a color adjusting process (process corresponding to function name information “Color”), weights are predetermined in such a manner that each of weight values corresponding to the floating-point operation and the memory capacity is set to be larger than any other weight value.

In the image formation designating apparatus 1, the sum of products of the corresponding weights and the values of resource information may be calculated as processing load information. In this manner, when setting is made so that throughput capacity becomes high as each value of resource information becomes as large as possible, it means that processing load becomes light (processing becomes rapid) as the value of processing load information becomes large. When setting is made so that throughput capacity becomes high as each parameter becomes as small as possible, it means that processing load becomes light (processing becomes rapid) as the value of processing load information becomes small.

When a setting item for selecting either of a corresponding function setting item in the common function setting information and a read function setting item is added to setting screen information of temporary integrated function setting information in the step S7, the image formation designating apparatus 1 may determine the initial state based on the processing load information. In an example in the exemplary embodiment, when a setting item for selecting either of a corresponding function setting item in the common function setting information and a read function setting item is added to setting screen information of temporary integrated function setting information in the step S7, the image formation designating apparatus 1 generates setting screen information based on the calculated processing load information with respect to the function setting item so that an option lighter in processing load (rapider in processing) is set as an initial-state option of the setting item.

### Example of Processing by Image Forming Apparatus

Although description has been made in the case where common function setting information per se is first set as temporary integrated function setting information, and if there is any function setting information overlapping with the function setting information acquired from the image forming apparatus 2, then the function setting information is selected (or an interface for selecting the function setting information is disposed) to perform integration without overlap, the function setting information acquired from the image forming apparatus 2 may be used directly as integrated function setting information by user's designation regardless of the common function setting information instead of this process. In this case, all processes for respective function setting items contained in the function setting information are performed by the image forming apparatus 2.

### Example of Provision of Setting Screen on Image Forming Apparatus Side

When a setting screen is written in HTML as shown in the aforementioned example, part or the whole of the setting screen may be acquired from another Web site through a communication unit such as a network and displayed.

For example, the image formation designating apparatus 1 may transmit common function setting information stored in the image formation designating apparatus 1 and function setting information acquired from the image forming apparatus 2 to a Web server device not shown. The Web server device may execute processing or the like as the integrating portion 33 to generate HTML data of the setting screen, and may transmit the HTML data to the image formation designating apparatus 1. When setting is made, the Web server device transmits contents of the setting as form information to the image formation designating apparatus 1 side. The image formation designating apparatus 1 transmits the transmitted information as setting information together with image information as a target of formation to the image forming apparatus 2.

The image formation designating apparatus 1 may access the Web server device during the integrating process so that a button or link set to open a Web page indicating another setting screen is disposed in a setting screen. Specifically, the image forming apparatus 2 operates as a Web server. As for the function predetermined to make more various expression than the expression on the function setting screen of the image formation designating apparatus 1, the Web page on the function setting screen is stored in advance. There is set in advance a user interface component in which designation is written so that a URL (Uniform Resource Locator) for specifying the Web page is defined as a function setting item of function setting information, and that the designation can make the image formation designating apparatus 1 access the Web page generated by the Web server device of the image forming apparatus 2 designated by the URL, acquire the Web page and display the Web page.

The user interface component for setting is disposed in the Web page on the predetermined setting screen. A result of the setting is transmitted to the image formation designating apparatus 1 side.

In this case, the user interface component for the image formation designating apparatus 1 to access the Web page is disposed in setting screen information generated by the integrating process. In the aforementioned example, instead of using the check box as described above, for example, a button for accessing the URL of the Web page indicating the setting screen for setting “stamp” held by the image forming apparatus 2 is disposed as a user interface component “stamp”. When the user clicks this button, the image formation designating apparatus 1 accesses the URL associated with the button, acquires the Web page indicating the setting screen for setting “stamp” from the image forming apparatus 2, and displays the Web page. Contents of setting performed on the Web page by the user are transmitted from the image forming apparatus 2 to the image formation designating apparatus 1 side. Upon reception of the contents of the setting, the image formation designating apparatus 1 generates a result of the setting received by the image formation designating apparatus 1 side and information of an image to be formed, as image formation designating information, and transmits the image formation designating information to the image forming apparatus 2. The image forming apparatus 2 performs processing in accordance with the setting to perform an image forming process.

Incidentally, the method that the image forming apparatus 2 receives the setting received on the Web page provided by the image forming apparatus 2 as described above, together with the setting received by the image formation designating apparatus 1 is not limited to the aforementioned method. For example, when a request of a Web page indicating a setting screen is received, the image forming apparatus 2 may issue a unique identifier and sends the identifier to the image formation designating apparatus 1 side. In the image forming apparatus 2, contents of setting performed on the Web page are stored while associated with the identifier. On the image formation designating apparatus 1 side, the identifier is transmitted, together with contents of setting received by the image formation designating apparatus 1 and information of an image to be formed, to the image forming apparatus 2. The image forming apparatus 2 may read out the contents of setting associated with the received identifier from the storage portion 22 and perform processing in accordance with the read contents of setting and the contents of setting received from the image formation designating apparatus 1 to thereby form an image.

According to the exemplary embodiment, it is possible to provide a setting screen in consideration of arrangement of setting items and restriction on functions.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

### Description of Reference Numerals and Signs

1 image formation designating apparatus, 2 image forming apparatus, 11, 21 control portion, 12, 22 storage portion, 13 operation portion, 14 display portion, 15, 23 communication portion, 24 image forming portion, 31 acquisition portion, 32 readout portion, 33 integrating portion, 34 presentation portion, 35 receiving portion, 36 designation generating portion, 37 transmitting portion.

What is claimed is:

1. An image forming system comprising an image formation designating apparatus and a given image forming apparatus,
wherein the image formation designating apparatus includes:
a common function setting information acquisition unit that acquires common function setting information for setting a function common to a plurality of image forming apparatuses including the given image forming apparatus;
an acquisition unit that acquires function setting information of the given image forming apparatus which is a destination of transmission of image formation designation from the given image forming apparatus, the function setting information including setting screen layout information for defining contents of a setting screen and setting item display information for defining a setting value corresponding to a function of the given image forming apparatus;
an integrated function setting information generating unit that integrates the common function setting information acquired by the common function setting information acquisition unit with the function setting information acquired by the acquisition unit and generates integrated function setting information based on the setting screen layout information and the setting item display information;
a presentation unit that presents a setting screen based on the integrated function setting information generated by the integrated function setting information generating unit;
a receiving unit that receives designation concerned with a setting of the function;
an image formation designating information generating unit that generates image formation designating information based on the designation received by the receiving unit and image information which is a target of image formation by the given image forming apparatus; and
a transmitting unit that transmits the image formation designating information generated by the image formation designating information generating unit to the given image forming apparatus; and
the given image forming apparatus includes:
a holding unit that holds function setting information concerned with functions and settings which is usable by the image forming apparatus;
a unit that receives a request to acquire the function setting information held by the holding unit from the image formation designating apparatus and transmits the function setting information to the image formation designating apparatus;
a receiving unit that receives the image formation designating information from the image formation designating apparatus; and
an image forming unit that forms an image based on the received image formation designating information.

2. An image formation designating apparatus comprising:
a common function setting information acquisition unit that acquires common function setting information for setting a function common to a plurality of image forming apparatuses including a given image forming apparatus;
an acquisition unit that acquires function setting information of the given image forming apparatus which is a destination of transmission of image formation designation from the given image forming apparatus, the function setting information including setting screen layout information for defining contents of a setting screen and setting item display information for defining a setting value corresponding to a function of the given image forming apparatus;
an integrated function setting information generating unit that integrates the common function setting information acquired by the common function setting information acquisition unit with the function setting information acquired by the acquisition unit and generates integrated function setting information based on the setting screen layout information and the setting item display information;
a presentation unit that presents a setting screen based on the integrated function setting information generated by the integrated function setting information generating unit;
a receiving unit that receives designation concerned with a setting of the function;
an image formation designating information generating unit that generates image formation designating information based on the designation received by the receiving unit and image information which is a target of image formation by the given image forming apparatus; and
a transmitting unit that transmits the image formation designating information generated by the image formation designating information generating unit to the given image forming apparatus.

3. The image formation designating apparatus according to claim 2, wherein when there are overlapping function setting items contained in both common function setting information and function setting information acquired by the acquisition unit, the integrated function setting information generating unit generates setting screen information indicating a setting screen containing a setting item for selecting one of the overlapping function setting items.

4. The image formation designating apparatus according to claim 3, wherein when different names are set for the overlapping function setting items contained in both the overlapping common function setting information and the function setting information acquired by the acquisition unit, the integrated function setting information generating unit generates setting screen information indicating a setting screen for displaying corresponding one of the names in accordance with selection in a setting item for selecting use of one of the overlapping function setting items.

5. The image formation designating apparatus according to claim 3 further comprising:
a resource information acquisition unit that acquires resource information concerned with processing resources of the given image forming apparatus; and
a processing load information generating unit that compares the resource information acquired by the resource information acquisition unit with resource information concerned with processing resources of the image formation designating apparatus per se, and generates information indicating processing loads when processing concerned with the function setting items in the given image forming apparatus as a destination of transmission of the image formation designation and the image formation designating apparatus respectively is performed for the respective overlapping function setting items, wherein:
the integrated function setting information generating unit uses the information of the processing loads generated by the processing load information generating unit to generate setting screen information indicating a setting screen displayed for the respective overlapping function setting items.

6. The image formation designating apparatus according to claim 5, wherein the integrated function setting information generating unit determines an initial state of the setting item for selecting whether the given image forming apparatus is used or whether the image formation designating apparatus is used, based on the information of the processing loads.

7. A computer readable medium storing a program causing a computer to execute a process for image formation designating, the process comprising:
acquiring common function setting information for setting a function common to a plurality of image forming apparatuses including a given image forming apparatus;
acquiring function setting information of the given image forming apparatus which is a destination of transmission of image formation designation from the given image forming apparatus, the function setting information including setting screen layout information for defining contents of a setting screen and setting item display information for defining a setting value corresponding to a function of the given image forming apparatus;
integrating the common function setting information with the function setting information;
generating integrated function setting information based on the setting screen layout information and the setting item display information;
presenting a setting screen based on the integrated function setting information;
receiving designation concerned with a setting of the function;
generating image formation designating information based on the designation; and
transmitting the image formation designating information to the given image forming apparatus.

8. The image formation designating apparatus according to claim 4 further comprising:
a resource information acquisition unit that acquires resource information concerned with processing resources of the given image forming apparatus; and
a processing load information generating unit that compares the resource information acquired by the resource information acquisition unit with resource information concerned with processing resources of the image formation designating apparatus per se, and generates information indicating processing loads when processing concerned with the function setting items in the given image forming apparatus as a destination of transmission of the image formation designation and the image formation designating apparatus respectively is performed for the respective overlapping function setting items, wherein:
the integrated function setting information generating unit uses the information of the processing loads generated by the processing load information generating unit to generate setting screen information indicating a setting screen displayed for the respective overlapping function setting items.

9. The image formation designating apparatus according to claim 8, wherein the integrated function setting information generating unit determines an initial state of the setting item for selecting whether the given image forming apparatus is used or whether the image formation designating apparatus is used, based on the information of the processing loads.
